(19) United States
(12) Patent Application Publication
(10) Pub. No.: US 2024/0127331 A1
(43) Pub. Date: Apr. 18, 2024

(54) METHOD AND SYSTEM FOR IMPROVING MODEL FAIRNESS BY USING EXPLAINABILITY TECHNIQUES

(71) Applicant: JPMorgan Chase Bank, N.A., New York, NY (US)

(72) Inventors: Ivan BRUGERE, Palo Alto, CA (US); Daniele MAGAZZENI, London (GB); Nicolas MARCHESOTTI, London (GB); David HEIKE, Toronto (CA); FengQin ZHAO, West Chester, PA (US); Eric WANG, McLean, VA (US); Huai SHU, Berkeley Heights, NJ (US); Mark GABRIEL, Jersey City, NJ (US); Manuela VELOSO, New York, NY (US); Cecilia TILLI, London (GB); Sanghamitra DUTTA, New York, NY (US); Bivor MALLIK, West Chester, PA (US); Ade ONIGBANJO, London (GB)

(73) Assignee: JPMorgan Chase Bank, N.A., New York, NY (US)

(21) Appl. No.: 17/968,220

(22) Filed: Oct. 18, 2022

(51) Int. Cl. G06Q 40/02

(52) U.S. Cl. CPC G06Q 40/025

(57) ABSTRACT

Methods and systems for generating a model to be used for evaluating credit and loan applications are provided. The method includes: training a first model by using all features included in a universe of candidate features; measuring a first metric that relates to an accuracy of the first model and a second metric that relates to a disparity of the first model; constructing a graph based on pairwise correlations of the features; clustering the features into feature sets; estimating a respective disparity contribution associated with each feature set; selecting feature sets to be included in a second model; training, the second model; measuring the first metric and the second metric with respect to the second model; and determining whether the second model satisfies a predetermined accuracy level and a predetermined disparity reduction with respect to the first model.

### BACKGROUND

### 1. Field of the Disclosure

This technology generally relates to methods and systems for reducing disparities in model development by leveraging explainability and clustering to guide model search via feature selection in order to achieve acceptable accuracy and lower disparity in lending practices.

### 2. Background Information

The Office of Fair Lending Analytics (OFLA) has developed reusable code to address Fair Lending model reviews that require Disparate Impact Analysis and/or Substitution Analysis, in order to reduce disparities with respect to race, gender, and age. One objective of Substitution Analysis is to answer the following question: Given a model that uses a certain set of features and where there is a larger set of additional features, which additional features can be added or existing features removed to train the model in order to achieve higher or similar accuracy and lower disparity?

A conventional approach uses a Monte Carlo Tree Search (MCTS) technique to select different sets of features, train models, and identify which models work well. However, a limitation of performing Substitution Analysis using MCTS is that it often takes a very long time to identify a model that satisfies certain search criteria due to the need for retraining many candidate models for different combinations of features.

Accordingly, there is a need for a method for improving model fairness by leveraging explainability and clustering to guide model search via feature selection in order to achieve acceptable accuracy and lower disparity in lending practices in an efficient manner.

### SUMMARY

The present disclosure, through one or more of its various aspects, embodiments, and/or specific features or sub-components, provides, inter alia, various systems, servers, devices, methods, media, programs, and platforms for methods and systems for improving model fairness by leveraging explainability and clustering to guide model search via feature selection in order to achieve acceptable accuracy and lower disparity in lending practices.

According to an aspect of the present disclosure, a method for generating a model to be used for, including but not exclusively, evaluating credit and loan applications is provided. The method is implemented by at least one processor. The method includes: training, by the at least one processor, a first model by using all features included in a predetermined plurality of candidate features; measuring, by the at least one processor, a first metric that relates to an accuracy of the first model and a second metric that relates to a disparity of the first model; constructing, by the at least one processor, a graph based on pairwise correlations of the features; clustering, by the at least one processor based on a result of the correlations, the features into a plurality of feature sets; estimating, by the at least one processor, a respective disparity contribution associated with each feature set from among a subset of the plurality of feature sets; selecting, by the at least one processor based on a result of the estimating, at least one feature set from among the plurality of feature sets to be included in a second model; training, by the at least one processor, the second model by using all features included in the selected at least one feature set; measuring, by the at least one processor, the first metric that relates to an accuracy of the second model and the second metric that relates to a disparity of the second model; and determining, by the at least one processor based on a result of the measuring with respect to the second model, whether the second model satisfies a predetermined accuracy level and a predetermined disparity reduction with respect to the first model.

The estimating may include applying a Shapley Additive exPlanations (SHAP) technique to each feature set from among the subset of the plurality of feature sets.

A union of all feature sets may be equivalent to the predetermined plurality of candidate features. An intersection between each respective pair of feature sets may be equivalent to an empty set.

The second metric may include at least one from among a metric that relates to a racial disparity, a metric that relates to a gender disparity, and a metric that relates to an age disparity.

The clustering may include applying a predetermined clustering algorithm to the pairwise correlations of the features.

When the second model is determined as not satisfying both of the predetermined accuracy level and the predetermined disparity reduction, the method may further include: generating a third model by selecting at least one additional feature set from among the subset of the plurality of feature sets and adding the additional feature set to the sets included in the second model; training the third model by using all features included in the second model and all features included in the at least one additional feature set; measuring the first metric that relates to an accuracy of the third model and the second metric that relates to a disparity of the third model; and determining, based on a result of the measuring with respect to the third model, whether the third model satisfies the predetermined accuracy level and the predetermined disparity reduction with respect to the first model.

Alternatively, when the second model is determined as not satisfying both of the predetermined accuracy level and the predetermined disparity reduction, the method may further include: generating a fourth model by selecting at least one feature set from among the sets included in the second model to be removed; training the fourth model by using all features included in the second model that have not been removed; measuring the first metric that relates to an accuracy of the fourth model and the second metric that relates to a disparity of the fourth model; and determining, based on a result of the measuring with respect to the fourth model, whether the fourth model satisfies the predetermined accuracy level and the predetermined disparity reduction with respect to the first model.

As another alternative, when the second model is determined as not satisfying both of the predetermined accuracy level and the predetermined disparity reduction, the method may further include: generating a fifth model by selecting at least one additional feature set from among the subset of the plurality of feature sets and adding the additional feature set to the sets included in the second model, and selecting at least one feature set from among the sets included in the second model to be removed; training the fifth model by using all features included in the second model that have not been removed and all features included in the at least one additional feature set; measuring the first metric that relates to an accuracy of the fifth model and the second metric that relates to a disparity of the fifth model; and determining, based on a result of the measuring with respect to the fifth model, whether the fifth model satisfies the predetermined accuracy level and the predetermined disparity reduction with respect to the first model.

According to another exemplary embodiment, a computing apparatus for generating a model to be used for, including but not limited to, evaluating credit and loan applications is provided. The computing apparatus includes a processor; a memory; and a communication interface coupled to each of the processor and the memory. The processor is configured to: train a first model by using all features included in a predetermined plurality of candidate features; measure a first metric that relates to an accuracy of the first model and a second metric that relates to a disparity of the first model; construct a graph based on pairwise correlations of the features; cluster, by the at least one processor based on a result of the correlations, the features into a plurality of feature sets; estimate a respective disparity contribution associated with each feature set from among a subset of the plurality of feature sets; select, based on a result of the estimation, at least one feature set from among the plurality of feature sets to be included in a second model; train the second model by using all features included in the selected at least one feature set; measure the first metric that relates to an accuracy of the second model and the second metric that relates to a disparity of the second model; and determine, by the at least one processor based on a result of the measurements with respect to the second model, whether the second model satisfies a predetermined accuracy level and a predetermined disparity reduction with respect to the first model.

The processor may be further configured to perform the estimation by applying a Shapley Additive exPlanations (SHAP) technique to each feature set from among the subset of the plurality of feature sets.

A union of all feature sets may be equivalent to the predetermined plurality of candidate features. An intersection between each respective pair of feature sets may be equivalent to an empty set.

The second metric may include at least one from among a metric that relates to a racial disparity, a metric that relates to a gender disparity, and a metric that relates to an age disparity.

The processor may be further configured to perform the clustering by applying a predetermined clustering algorithm to the pairwise correlations of the features.

When the second model is determined as not satisfying both of the predetermined accuracy level and the predetermined disparity reduction, the processor may be further configured to: generate a third model by selecting at least one additional feature set from among the subset of the plurality of feature sets and adding the additional feature set to the sets included in the second model; train the third model by using all features included in the second model and all features included in the at least one additional feature set; measure the first metric that relates to an accuracy of the third model and the second metric that relates to a disparity of the third model; and determine, based on a result of the measurements with respect to the third model, whether the third model satisfies the predetermined accuracy level and the predetermined disparity reduction with respect to the first model.

Alternatively, when the second model is determined as not satisfying both of the predetermined accuracy level and the predetermined disparity reduction, the processor may be further configured to: generate a fourth model by selecting at least one feature set from among the sets included in the second model to be removed; train the fourth model by using all features included in the second model that have not been removed; measure the first metric that relates to an accuracy of the fourth model and the second metric that relates to a disparity of the fourth model; and determine, based on a result of the measurements with respect to the fourth model, whether the fourth model satisfies the predetermined accuracy level and the predetermined disparity reduction with respect to the first model.

As another alternative, when the second model is determined as not satisfying both of the predetermined accuracy level and the predetermined disparity reduction, the processor may be further configured to: generate a fifth model by selecting at least one additional feature set from among the subset of the plurality of feature sets and adding the additional feature set to the sets included in the second model, and selecting at least one feature set from among the sets included in the second model to be removed; train the fifth model by using all features included in the second model that have not been removed and all features included in the at least one additional feature set; measure the first metric that relates to an accuracy of the fifth model and the second metric that relates to a disparity of the fifth model; and determine, based on a result of the measurements with respect to the fifth model, whether the fifth model satisfies the predetermined accuracy level and the predetermined disparity reduction with respect to the first model.

According to yet another exemplary embodiment, a non-transitory computer readable storage medium storing instructions for generating a model to be used for, including but not exclusively, evaluating credit and loan applications is provided. The storage medium includes executable code which, when executed by a processor, causes the processor to: train a first model by using all features included in a predetermined plurality of candidate features; measure a first metric that relates to an accuracy of the first model and a second metric that relates to a disparity of the first model; construct a graph based on pairwise correlations of the features; cluster, based on a result of the correlations, the features into a plurality of feature sets; estimate a respective disparity contribution associated with each feature set from among a subset of the plurality of feature sets; select, based on a result of the estimation, at least one feature set from among the plurality of feature sets to be included in a second model; train the second model by using all features included in the selected at least one feature set; measure the first metric that relates to an accuracy of the second model and the second metric that relates to a disparity of the second model; and determine, based on a result of the measurements with respect to the second model, whether the second model satisfies the predetermined accuracy level and the predetermined disparity reduction with respect to the first model.

When executed by the processor, the executable code may be further configured to perform the estimation by applying a Shapley Additive exPlanations (SHAP) technique to each feature set from among the subset of the plurality of feature sets.

A union of all feature sets may be equivalent to the predetermined plurality of candidate features. An intersection between each respective pair of feature sets may be equivalent to an empty set.

The second metric may include at least one from among a metric that relates to a racial disparity, a metric that relates to a gender disparity, and a metric that relates to an age disparity.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for improving model fairness by leveraging explainability and clustering to guide model search via feature selection in order to achieve acceptable accuracy and lower disparity in lending practices.

FIG. 4 is a flowchart of an exemplary process for implementing a method for improving model fairness by leveraging explainability and clustering to guide model search via feature selection in order to achieve acceptable accuracy and lower disparity in lending practices.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

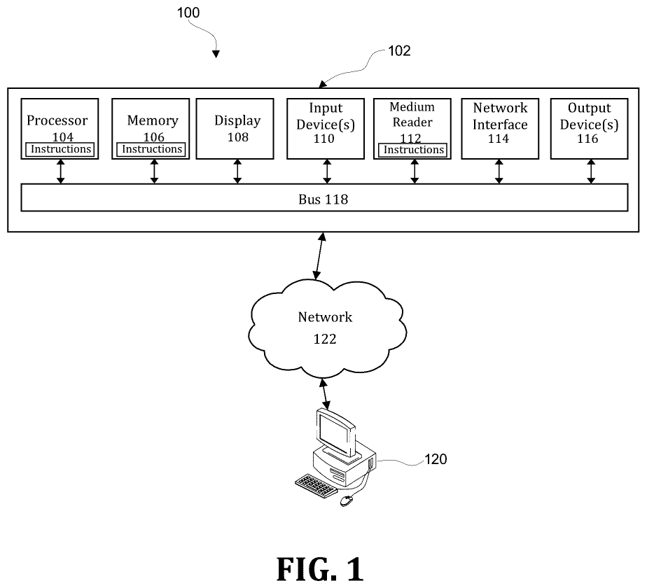

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for improving model fairness by leveraging explainability and clustering to guide model search via feature selection in order to achieve acceptable accuracy and lower disparity in lending practices.

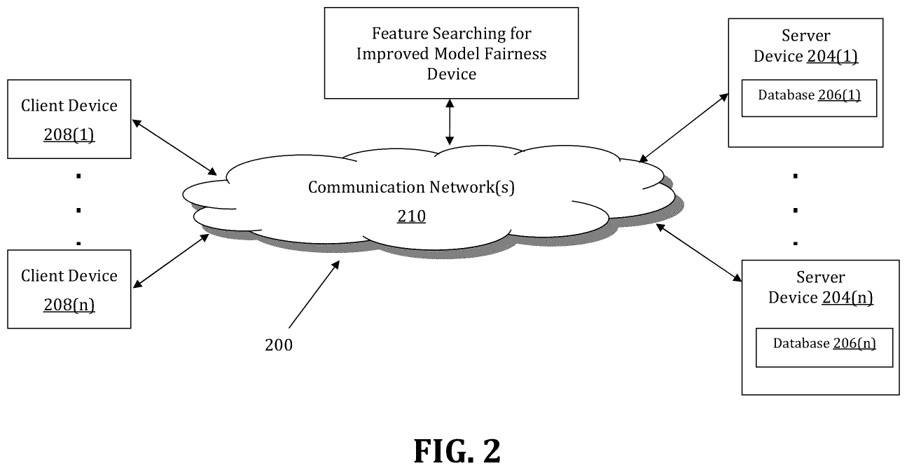

Referring to FIG. 2, a schematic of an exemplary network environment 200 for implementing a method for improving model fairness by leveraging explainability and clustering to guide model search via feature selection in order to achieve acceptable accuracy and lower disparity in lending practices is illustrated. In an exemplary embodiment, the method is executable on any networked computer platform, such as, for example, a personal computer (PC).

The method for improving model fairness by leveraging explainability and clustering to guide model search via feature selection in order to achieve acceptable accuracy and lower disparity in lending practices may be implemented by a Feature Searching for Improved Model Fairness (FSIMF) device 202. The FSIMF device 202 may be the same or similar to the computer system 102 as described with respect to FIG. 1. The FSIMF device 202 may store one or more applications that can include executable instructions that, when executed by the FSIMF device 202, cause the FSIMF device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the FSIMF device 202 itself, may be located in virtual server(s) running in a cloud-based computing environment rather than being tied to one or more specific physical network computing devices. Also, the application(s) may be running in one or more virtual machines (VMs) executing on the FSIMF device 202. Additionally, in one or more embodiments of this technology, virtual machine(s) running on the FSIMF device 202 may be managed or supervised by a hypervisor.

In the network environment 200 of FIG. 2, the FSIMF device 202 is coupled to a plurality of server devices 204(1)-204(n) that hosts a plurality of databases 206(1)-206(n), and also to a plurality of client devices 208(1)-208(n) via communication network(s) 210. A communication interface of the FSIMF device 202, such as the network interface 114 of the computer system 102 of FIG. 1, operatively couples and communicates between the FSIMF device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the FSIMF device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and FSIMF devices that efficiently implement a method for improving model fairness by leveraging explainability and clustering to guide model search via feature selection in order to achieve acceptable accuracy and lower disparity in lending practices.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The FSIMF device 202 may be a standalone device or integrated with one or more other devices or apparatuses, such as one or more of the server devices 204(1)-204(n), for example. In one particular example, the FSIMF device 202 may include or be hosted by one of the server devices 204(1)-204(n), and other arrangements are also possible. Moreover, one or more of the devices of the FSIMF device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the FSIMF device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to candidate model features and information that relates to model-specific accuracy and disparity metrics.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the FSIMF device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the FSIMF device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the FSIMF device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the FSIMF device 202, the server devices 204(1)-204(n), or the client devices 208(1)-208(n), for example, may be configured to operate as virtual instances on the same physical machine. In other words, one or more of the FSIMF device 202, the server devices 204(1)-204(n), or the client devices 208(1)-208(n) may operate on the same physical device rather than as separate devices communicating through communication network(s) 210. Additionally, there may be more or fewer FSIMF devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

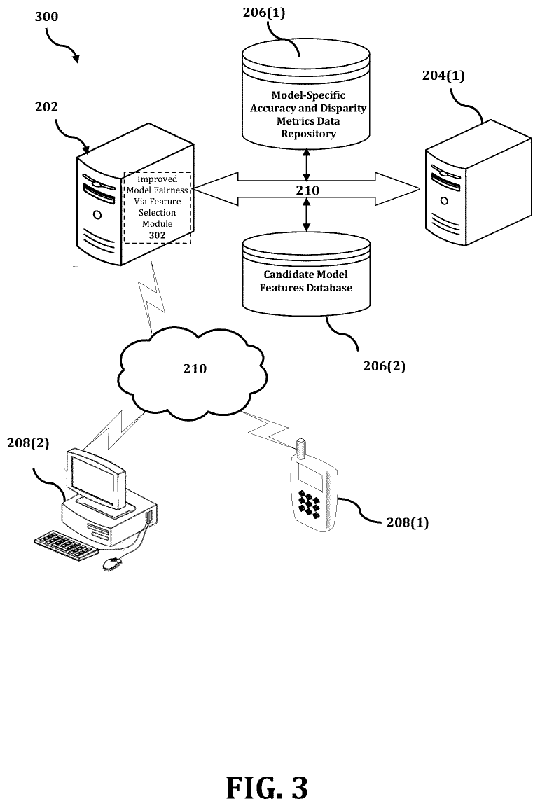

The FSIMF device 202 is described and illustrated in FIG. 3 as including an improved model fairness via feature selection module 302, although it may include other rules, policies, modules, databases, or applications, for example. As will be described below, the improved model fairness via feature selection module 302 is configured to implement a method for improving model fairness by leveraging explainability and clustering to guide model search via feature selection in order to achieve acceptable accuracy and lower disparity in lending practices.

An exemplary process 300 for implementing a mechanism for improving model fairness by leveraging explainability and clustering to guide model search via feature selection in order to achieve acceptable accuracy and lower disparity in lending practices by utilizing the network environment of FIG. 2 is illustrated as being executed in FIG. 3. Specifically, a first client device 208(1) and a second client device 208(2) are illustrated as being in communication with FSIMF device 202. In this regard, the first client device 208(1) and the second client device 208(2) may be “clients” of the FSIMF device 202 and are described herein as such. Nevertheless, it is to be known and understood that the first client device 208(1) and/or the second client device 208(2) need not necessarily be “clients” of the FSIMF device 202, or any entity described in association therewith herein. Any additional or alternative relationship may exist between either or both of the first client device 208(1) and the second client device 208(2) and the FSIMF device 202, or no relationship may exist.

Further, FSIMF device 202 is illustrated as being able to access a model-specific accuracy and disparity metrics data repository 206(1) and a candidate model features database 206(2). The improved model fairness via feature selection module 302 may be configured to access these databases for implementing a method for improving model fairness by leveraging explainability and clustering to guide model search via feature selection in order to achieve acceptable accuracy and lower disparity in lending practices.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the FSIMF device 202 via broadband or cellular communication. Of course, these embodiments are merely exemplary and are not limiting or exhaustive.

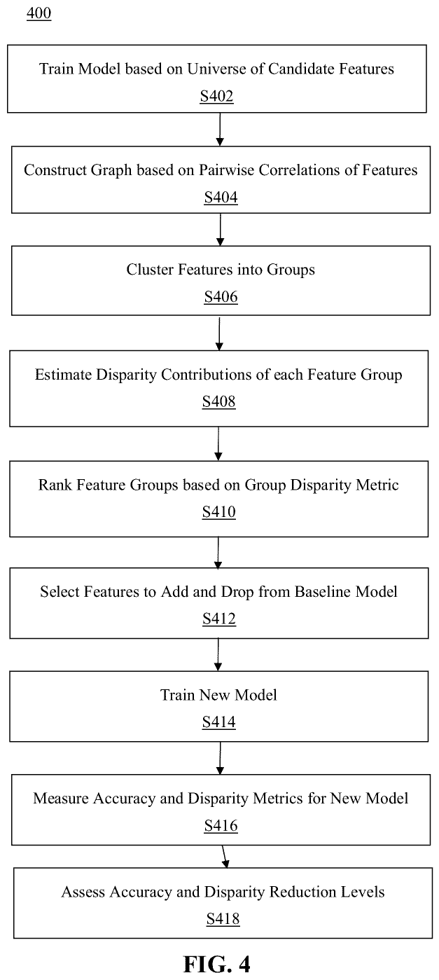

Upon being started, the improved model fairness via feature selection module 302 executes a process for improving model fairness by leveraging explainability and clustering to guide model search via feature selection in order to achieve acceptable accuracy and lower disparity in lending practices. An exemplary process for improving model fairness by leveraging explainability and clustering to guide model search via feature selection in order to achieve acceptable accuracy and lower disparity in lending practices is generally indicated at flowchart 400 in FIG. 4.

In process 400 of FIG. 4, at step S402, the improved model fairness via feature selection module 302 trains a model that is intended to be used for evaluating credit and loan applications, based on a universe of candidate features that are available for inclusion in the model. In an exemplary embodiment, the accuracy of the model refers to a probability that the output of the model matches with an independent determination that a particular credit application or a particular loan application would be accepted or rejected.

In an exemplary embodiment, the disparity of the model refers to a degree to which the acceptance or rejection of a particular credit application or a particular loan application has a disparate impact upon a particular group of applicants based on some characteristic for which such a disparate impact is undesirable because it is deemed as being relatively biased or unfair with respect to fair lending principles. For example, a metric that indicates a disparity of the model may be measured in terms of a metric that relates to a racial disparity, a metric that relates to a gender disparity, a metric that relates to an age disparity, and/or any other suitable type of metric that relates to a disparity that is deemed as being prejudicial or biased with respect to a particular group of individuals.

At step S404, the improved model fairness via feature selection module 302 constructs a graph based on pairwise correlations of the features included in the universal set of candidate features. Then, at step S406, the improved model fairness via feature selection module 302 uses the correlations from the constructed graph to cluster the candidate features into groups, i.e., feature sets. In an exemplary embodiment, the clustering of features into feature sets is performed on the basis of similarities between the features, and as a result, each resulting feature set includes features that are relatively similar to one another, as indicated by the pairwise correlations used to construct the graph in step S404.

In an exemplary embodiment, the feature sets that result from the clustering operation in step S406 are mutually exclusive sets, and each and every feature included in the universal set of candidate features is included in one of the feature sets. This quality may be expressed mathematically as follows: A union of all feature sets is equivalent to the universal set of candidate features, and an intersection between each respective pair of feature sets is equivalent to an empty set.

At step S408, the improved model fairness via feature selection module 302 estimates respective disparity contributions of some or all of the feature sets that are generated by the clustering operation of step S406, in order to generate a respective group disparity metric for each feature set. In an exemplary embodiment, the estimation operation is performed by applying a Shapley Additive exPlanations (SHAP) technique to each feature set, in order to efficiently compute feature explanations with respect to individual features in a mathematically robust manner and then evaluate fairness using adjusted model predictions. Then, at step S410, the improved model fairness via feature selection module 302 ranks the feature sets based on the group disparity metric. Then, at step S412, the improved model fairness via feature selection module 302 selects features from within the feature sets to be included in a new model, for example, by adding to and/or removing features from the original baseline model, based on the estimates resulting from step S410. In an exemplary embodiment, the objective of the new model is to reduce the disparities generated by the original baseline model while maintaining an acceptable level of accuracy in making decisions as to whether to accept or reject a particular application for a loan or for credit.

At step S414, the improved model fairness via feature selection module 302 trains the new model based on a subset of features included in the feature sets selected in step S412. Then, at step S416, the improved model fairness via feature selection module 302 measures accuracy and disparity metrics for the new model. Then, at step S418, the improved model fairness via feature selection module 302 assesses the accuracy and disparity reduction levels associated with the new model, based on the metrics measured in step S416, in order to determine whether the new model is sufficiently accurate and also achieves the objective of reducing disparities to a desired level.

In an exemplary embodiment, the assessment of step S418 is performed by comparing the metrics measured in step S416 with the corresponding metrics of the original model, and also using predetermined thresholds for the differences between the metrics to determine the accuracy level and the amount(s) of disparity reduction. When a determination is made that the new model is sufficiently accurate and that there is a sufficient disparity reduction with respect to the original model, then the process 400 is complete. However, when a determination is made that the new model fails to achieve either sufficient accuracy or sufficient disparity reduction, the process 400 may return to step S412 to select different feature sets for another new model, and then repeat steps S414, S416, and S418 to determine whether this additional new model is satisfactory. In an exemplary embodiment, the selection of different feature sets may be implemented in at least three different ways: In a first option, the feature sets selected in the first instance may be retained, and at least one additional feature set may be added, in order to expand the number of feature sets to be included in the new model. In a second option, at least one of the feature sets selected in the first instance may be removed, with no additions of other feature sets, in order to reduce the number of features sets to be included in the new model. In a third option, there may be combination of the first and second options, whereby at least one of the feature sets that was selected in the first instance is removed, and there is also an addition of at least one feature set that had previously not been selected.

In an exemplary embodiment, an objective is to generate a model that is intended to be used for evaluating credit and loan applications, based on a universe of candidate features that are available for inclusion in the model. In this aspect, given a baseline model that uses a small set of baseline features out of a larger set of available candidate features, a goal is to search for a better model by using substitution analysis, i.e., by swapping out some of the baseline features and swapping in some new features out of the larger set of available features. The objective is essentially to find a subset of features from a large set of available features that would lead to a model with acceptable accuracy, based on the accuracy of the baseline model, and lower disparity, i.e., higher fairness scores.

Typically, such a model search could take a large amount of time since one has to consider all possible combinations of features, train new models for many of those combinations, and then search for the best model. In an exemplary embodiment, this conventional search procedure is improved by leveraging explainability techniques and correlation metrics. The explainability techniques leverage SHAP, which provides an efficient implementation for tree-based models to compute the feature explanations at the level of individual features (i.e., Shapley Values). Shapley Values provide a framework with which feature explanations can be computed in a mathematically robust way. However, in an exemplary embodiment, the use of the SHAP technique is not exclusive to tree-based models.

In order to carry out the solution, in an exemplary embodiment, the first step is to train a big model that uses all the features in the set of available features. Next, similar features are grouped together using a clustering technique; in an exemplary embodiment, these are features that could potentially substitute for one another if any one of them were swapped out. Then, SHAP is applied to quantify the contribution of each group of features to the model output and to the model disparity. In this manner, the groups of features may be ranked based on the relative sizes of their disparity contributions. After the ranking, features from the highly contributing groups may be swapped out, and new features from the least contributing groups may be included.

In an exemplary embodiment, a method for improving model fairness by leveraging explainability and clustering to guide model search via feature selection in order to achieve acceptable accuracy and lower disparity in lending practices may include the following operations:

1. Train a new model h(S_{N}) using all the features S_{N}. It is noted that subtracting a SHAP contribution of a feature Xᵢ⊆S_{N} from h(S_{N}) is different from retraining using S_{N}\Xᵢ, particularly when Xᵢ is highly correlated with other features in S_{N}\Xᵢ.

2. Construct a graph based on pair-wise correlation of all features in S_{N}, and then use a clustering algorithm to get groups of features, namely, G₁, G₂, . . . ,G_{K}⊆S_{N}, where S_{N} is the large set of features.

In an exemplary embodiment, it is noted that Gᵢ∩Gⱼ=ϕ, and G₁∪G₂∪ . . . Gₖ=S_{N}.

3. Try to find a set of groups S⊆{G₁,G₂, . . . ,G_{K}} such that h_{retrained}(S) would have acceptable accuracy and fairness. At a group level, it may be assumed that h_{retrained}(S_{N}\Gⱼ)≈h(S_{N})−Ωⱼ(S_{N}), where Ωⱼ(S_{N}) is the SHAP-based contribution of group Gⱼ.

4. Swap out, by dropping the features in the original model S_{baseline} that have an intersection with groups that may contribute most to disparity; and swap in, by adding features from groups in S_{N} to which none of the features in S_{baseline} belong that may contribute least to disparity to create feature set S. Then, check actual fairness and accuracy of h_{retrained}(S) and compare to h(S_{baseline}) as determined with respect to the original model.

5. Repeat for first few subsets S in step 3 if required.

Accordingly, with this technology, an optimized process for improving model fairness by leveraging explainability and clustering to guide model search via feature selection in order to achieve acceptable accuracy and lower disparity in lending practices is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a model to be used for evaluating credit and loan applications, the method being implemented by at least one processor, the method comprising:
training, by the at least one processor, a first model by using all features included in a predetermined plurality of candidate features;
measuring, by the at least one processor, a first metric that relates to an accuracy of the first model and a second metric that relates to a disparity of the first model;
constructing, by the at least one processor, a graph based on pairwise correlations of the features;
clustering, by the at least one processor based on a result of the correlations, the features into a plurality of feature sets;
estimating, by the at least one processor, a respective disparity contribution associated with each feature set from among a subset of the plurality of feature sets;
selecting, by the at least one processor based on a result of the estimating, at least one feature set from among the subset of the plurality of feature sets to be included in a second model;
training, by the at least one processor, the second model by using all features included in the selected at least one feature set;
measuring, by the at least one processor, the first metric that relates to an accuracy of the second model and the second metric that relates to a disparity of the second model; and
determining, by the at least one processor based on a result of the measuring with respect to the second model, whether the second model satisfies a predetermined accuracy level and a predetermined disparity reduction with respect to the first model.

2. The method of claim 1, wherein the estimating comprises applying a Shapley Additive exPlanations (SHAP) technique to each feature set from among the subset of the plurality of feature sets.

3. The method of claim 1, wherein a union of all feature sets is equivalent to the predetermined plurality of candidate features, and wherein an intersection between each respective pair of feature sets is equivalent to an empty set.

4. The method of claim 1, wherein the second metric includes at least one from among a metric that relates to a racial disparity, a metric that relates to a gender disparity, and a metric that relates to an age disparity.

5. The method of claim 1, wherein the clustering comprises applying a predetermined clustering algorithm to the pairwise correlations of the features.

6. The method of claim 1, wherein when the second model is determined as not satisfying both of the predetermined accuracy level and the predetermined disparity reduction, the method further comprises:
generating a third model by selecting at least one additional feature set from among the subset of the plurality of feature sets and adding the additional feature set to the sets included in the second model;
training the third model by using all features included in the second model and all features included in the at least one additional feature set;
measuring the first metric that relates to an accuracy of the third model and the second metric that relates to a disparity of the third model; and
determining, based on a result of the measuring with respect to the third model, whether the third model satisfies the predetermined accuracy level and the predetermined disparity reduction with respect to the first model.

7. The method of claim 1, wherein when the second model is determined as not satisfying both of the predetermined accuracy level and the predetermined disparity reduction, the method further comprises:
generating a fourth model by selecting at least one feature set from among the sets included in the second model to be removed;
training the fourth model by using all features included in the second model that have not been removed;
measuring the first metric that relates to an accuracy of the fourth model and the second metric that relates to a disparity of the fourth model; and
determining, based on a result of the measuring with respect to the fourth model, whether the fourth model satisfies the predetermined accuracy level and the predetermined disparity reduction with respect to the first model.

8. The method of claim 1, wherein when the second model is determined as not satisfying both of the predetermined accuracy level and the predetermined disparity reduction, the method further comprises:
generating a fifth model by selecting at least one additional feature set from among the subset of the plurality of feature sets and adding the additional feature set to the sets included in the second model, and selecting at least one feature set from among the sets included in the second model to be removed;
training the fifth model by using all features included in the second model that have not been removed and all features included in the at least one additional feature set;
measuring the first metric that relates to an accuracy of the fifth model and the second metric that relates to a disparity of the fifth model; and
determining, based on a result of the measuring with respect to the fifth model, whether the fifth model satisfies the predetermined accuracy level and the predetermined disparity reduction with respect to the first model.

9. A computing apparatus for generating a model to be used for evaluating credit and loan applications, the computing apparatus comprising:
a processor;
a memory; and
a communication interface coupled to each of the processor and the memory,
wherein the processor is configured to:
train a first model by using all features included in a predetermined plurality of candidate features;
measure a first metric that relates to an accuracy of the first model and a second metric that relates to a disparity of the first model;
construct a graph based on pairwise correlations of the features;
cluster, by the at least one processor based on a result of the correlations, the features into a plurality of feature sets;
estimate a respective disparity contribution associated with each feature set from among a subset of the plurality of feature sets;
select, based on a result of the estimation, at least one feature set from among the subset of the plurality of feature sets to be included in a second model;
train the second model by using all features included in the selected at least one feature set;
measure the first metric that relates to an accuracy of the second model and the second metric that relates to a disparity of the second model; and
determine, by the at least one processor based on a result of the measurements with respect to the second model, whether the second model satisfies a predetermined accuracy level and a predetermined disparity reduction with respect to the first model.

10. The computing apparatus of claim 9, wherein the processor is further configured to perform the estimation by applying a Shapley Additive exPlanations (SHAP) technique to each feature set from among the subset of the plurality of feature sets.

11. The computing apparatus of claim 9, wherein a union of all feature sets is equivalent to the predetermined plurality of candidate features, and wherein an intersection between each respective pair of feature sets is equivalent to an empty set.

12. The computing apparatus of claim 9, wherein the second metric includes at least one from among a metric that relates to a racial disparity, a metric that relates to a gender disparity, and a metric that relates to an age disparity.

13. The computing apparatus of claim 9, wherein the processor is further configured to perform the clustering by applying a predetermined clustering algorithm to the pairwise correlations of the features.

14. The computing apparatus of claim 9, wherein when the second model is determined as not satisfying both of the predetermined accuracy level and the predetermined disparity reduction, the processor is further configured to:
generate a third model by selecting at least one additional feature set from among the subset of the plurality of feature sets and adding the additional feature set to the sets included in the second model;
train the third model by using all features included in the second model and all features included in the at least one additional feature set;
measure the first metric that relates to an accuracy of the third model and the second metric that relates to a disparity of the third model; and
determine, based on a result of the measurements with respect to the third model, whether the third model satisfies the predetermined accuracy level and the predetermined disparity reduction with respect to the first model.

15. The computing apparatus of claim 9, wherein when the second model is determined as not satisfying both of the predetermined accuracy level and the predetermined disparity reduction, the processor is further configured to:
generate a fourth model by selecting at least one feature set from among the sets included in the second model to be removed;
train the fourth model by using all features included in the second model that have not been removed;
measure the first metric that relates to an accuracy of the fourth model and the second metric that relates to a disparity of the fourth model; and
determine, based on a result of the measurements with respect to the fourth model, whether the fourth model satisfies the predetermined accuracy level and the predetermined disparity reduction with respect to the first model.

16. The computing apparatus of claim 9, wherein when the second model is determined as not satisfying both of the predetermined accuracy level and the predetermined disparity reduction, the processor is further configured to:
generate a fifth model by selecting at least one additional feature set from among the subset of the plurality of feature sets and adding the additional feature set to the sets included in the second model, and selecting at least one feature set from among the sets included in the second model to be removed;
train the fifth model by using all features included in the second model that have not been removed and all features included in the at least one additional feature set;
measure the first metric that relates to an accuracy of the fifth model and the second metric that relates to a disparity of the fifth model; and
determine, based on a result of the measurements with respect to the fifth model, whether the fifth model satisfies the predetermined accuracy level and the predetermined disparity reduction with respect to the first model.

17. A non-transitory computer readable storage medium storing instructions for generating a model to be used for evaluating credit and loan applications, the storage medium comprising executable code which, when executed by a processor, causes the processor to:
train a first model by using all features included in a predetermined plurality of candidate features;
measure a first metric that relates to an accuracy of the first model and a second metric that relates to a disparity of the first model;
construct a graph based on pairwise correlations of the features;
cluster, based on a result of the correlations, the features into a plurality of feature sets;
estimate a respective disparity contribution associated with each feature set from among a subset of the plurality of feature sets;
select, based on a result of the estimation, at least one feature set from among the subset of the plurality of feature sets to be included in a second model;
train the second model by using all features included in the selected at least one feature set;
measure the first metric that relates to an accuracy of the second model and the second metric that relates to a disparity of the second model; and
determine, based on a result of the measurements with respect to the second model, whether the second model satisfies the predetermined accuracy level and the predetermined disparity reduction with respect to the first model.

18. The storage medium of claim 17, wherein when executed by the processor, the executable code is further configured to perform the estimation by applying a Shapley Additive exPlanations (SHAP) technique to each feature set from among the subset of the plurality of feature sets.

19. The storage medium of claim 17, wherein a union of all feature sets is equivalent to the predetermined plurality of candidate features, and wherein an intersection between each respective pair of feature sets is equivalent to an empty set.

20. The storage medium of claim 17, wherein the second metric includes at least one from among a metric that relates to a racial disparity, a metric that relates to a gender disparity, and a metric that relates to an age disparity.
